(19) United States
(12) Patent Application Publication
(10) Pub. No.: US 2010/0213806 A1
(43) Pub. Date: Aug. 26, 2010

(54) TRICHROMATIC LIGHT EMITTING DEVICE

(76) Inventors: Pheng-Piao Liao, Miaoli Hsien (TW); Kao-Ling Chen, Miaoli Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/392,570

(22) Filed: Feb. 25, 2009

(51) Int. Cl. H01J 61/94

(52) U.S. Cl. 313/1

(57) ABSTRACT

A trichromatic light emitting device has a substrate, multiple light emitting diodes (LED) and a red-light inducible phosphor layer. The substrate has a mounting surface. The LEDs have at least one green and at least one blue LED respectively emitting blue and green light along at least one output pathway and are mounted on the mounting surface of the substrate. The red-light inducible phosphor layer is disposed in the at least one output pathway and absorbs blue or green light to produce red light. Therefore, a white light is generated by mixing the blue green and red light.

### BACKGROUND OF THE INVENTION

1. Field of Invention

The present invention relates to a trichromatic light emitting device, and more particularly to a light emitting device comprising at least one blue light emitting diode (LED) and at least one green LED.

2. Description of the Related Art

Light emitting diodes (LEDs) are currently replacing conventional lighting devices such like incandescent bulbs, fluorescent lamps, bulbs, and halogen lamps since LEDs are power saving and environmental friendly so are cheaper and have higher efficiency. White light may be produced by a phosphor based white LED or an RGB LED array.

The phosphor based white LED comprises a short wavelength LED and a phosphor target. The short wavelength LED may be a blue LED or an ultraviolet LED emits a shorter wavelength light to pump the phosphor and generate longer wavelength light, so white light is mixed from shorter and longer wavelength lights. However, intensity of the green and red light is fractionally less than blue so the mixed white light is not white but slightly blue which may feel cool or uncomfortable.

In the RGB LED array, red, green and blue LEDs are combined to emit a uniform white light since intensities of the LEDs may be ad just independently. However, the white light from the RGB LED array may suffer color shift issue since the red, green, blue LEDs are respectively produced with different materials so have different lifetimes. Generally, blue and green LEDs are normally GaN-based but red LED are GaAs-based. Hence, the blue and green LEDs have close properties (lifetime, input power, intensities . . . etc.) but the red LED is not, so the color shift tends towards blue since the red LED normally decays faster thereby creating a similar cool and uncomfortable light.

Further, since input powers (input voltages) are different between the blue and green LEDs and the red LED, designing a driving circuit for the RGB LED array is troublesome and increases manufacture costs.

The present invention provides a trichromatic light emitting device to obviate or mitigate the shortcomings of the conventional white LED.

### SUMMARY OF THE INVENTION

The primary objective of the present invention is to provide a trichromatic light emitting device with at least one blue and at least one green light emitting diode to pump a red-light inducible phosphor to produce a trichromatic light emitting device with longer lifetime and reduced cost.

The trichromatic light emitting device has a substrate, multiple light emitting diodes (LEDs) and a red-light inducible phosphor layer. The substrate has a mounting surface. The LEDs consist of at least one green and at least one blue LEDs respectively emitting blue and green light along at least one output pathway and are mounted on the mounting surface of the substrate. The red-light inducible phosphor layer is disposed in the at least one output pathway and absorbs blue or green light to produce red light. Therefore, a white light is generated by mixing the blue, green and red light.

Other objectives advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a trichromatic light emitting device in accordance with the present invention;

FIG. 2 is a side view of the trichromatic light emitting device in FIG. 1;

FIG. 3 is a perspective view in partial section of a second embodiment of the trichromatic light emitting device in accordance with the present invention;

FIG. 4 is a perspective view of a third embodiment of a trichromatic light emitting device in accordance with the present invention implemented with two blue light emitting diodes (LEDs) and one green LED;

FIG. 5 is a perspective view of a forth embodiment of a trichromatic light emitting device in accordance with the present invention implemented with one blue LED and two green LEDs; and

FIG. 6 is a perspective view in partial section of a fifth embodiment of a trichromatic light emitting device in accordance with the present invention adopted as a light source of a flash light.

### DETAILED DESCRIPTION OF THE INVENTION

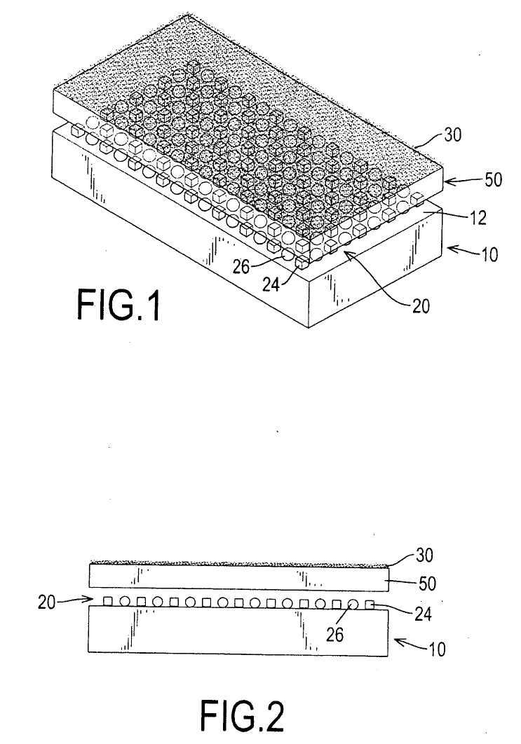

With reference to FIGS. 1 to 4 and 6, a trichromatic light emitting device in accordance with the present invention comprises a substrate (10), multiple light emitting diodes (LEDs) (20) and a red-light inducible phosphor layer (30) and may have a lens (40) and an optional functional film (50).

The substrate (10) may be a printed circuit board, a reflective cup or the like and has a mounting surface (12).

The mounting surface (12) of the reflective cup may be recessed. The LEDs (20) are mounted on the mounting surface (12) of the substrate (10), are connected to an external power source and consist of at least one blue LED (24) and at least one green LED (26) and respectively emitting blue and green light along at least one output pathway. A ratio of blue and green LEDs (24, 26) may be adjusted to attain a preferred color balance.

The red-light inducible phosphor layer (30) is disposed in at least one of the at least one output pathway to absorb short wavelength light (i.e. blue and green light) and reemit red light. Material of the red-light inducible phosphor layer (30) may be but not limited to SrS:Eu²⁺, (Ba₁₋ₓSrₓ)₂SiO₄:Eu²⁺ and (Ca,Sr,Ba)ₓSi_{y}N_{z}:Eu. For instance, the red-light phosphor layer (30) may be disposed in the output pathway of one blue LED (24) thereby absorbs a part of the blue light emitted from the blue LED (24) to generate the red light. The red-light phosphor layer (30) in the output pathway of the LEDs (20) may have a concentration. The concentration is adapted to allow a transmission ratio of blue and green light, so as intensity of the blue and green light and the reemitted red light may be adjusted to form a better color balance. The blue, green and red light are mixed to produce white light from the LEDs (20).

In FIGS. 1, 2 and 6, the substrate (10) is a printed circuit board and the multiple blue and green LEDs (24, 26) are mounted on the mounting surface (12) of the substrate (10) as a matrix. The red-light inducible phosphor layer (30) may cover at least one output pathway of the blue and green LED (24, 26) directly, or may be uniformly deposited on the functional film (50) coinciding with the output pathway of all blue and green LEDs (24, 26). The functional film (50) may -be a polarizer film, a Fresnel Lens film, a transparent film, a color filter film or the like. Hence, the substrate (10) with the blue and green LEDs (24, 26) may be a light source for a flash light (70).

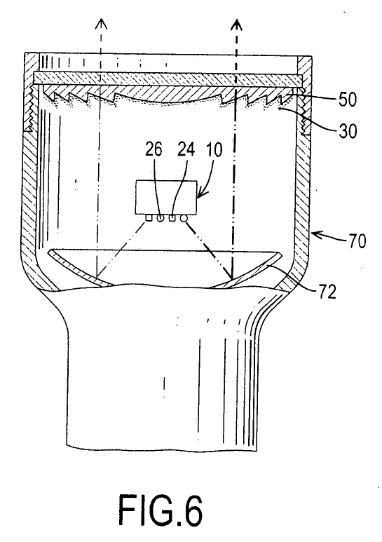

With reference to FIG. 6, a flash light (70) having the trichromatic light emitting device in accordance with the present invention further has a reflector (72) and the reflector (72) reflects light to the functional film (50) being a Fresnel lens having the red-light inducible phosphor layer (30) formed thereon. Therefore, a part of the blue and green light are used to induce the red-light inducible phosphor layer (30) to generate the red light and focused white light is generated after the blue, green and red light passes through the functional film (50).

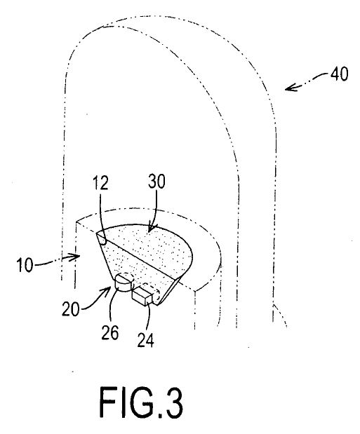

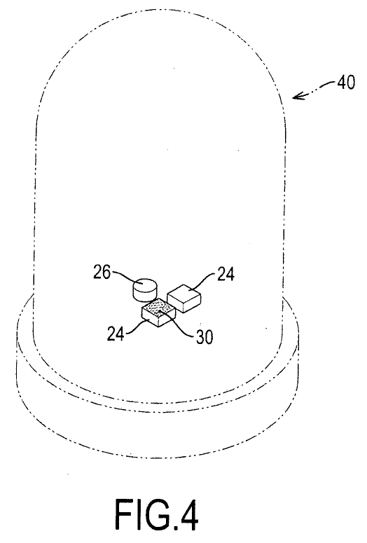

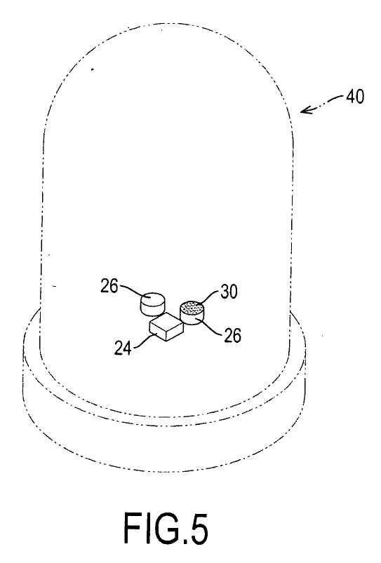

In a second embodiment of the present invention as shown in FIGS. 3, 4 and 5, the trichromatic light emitting device is packed as an element by using the lens (40). In the second embodiment, the substrate (10) is the reflective cup and the at least one blue LED (24) and the at least one green LED (26) are mounted on the mounting surface (12) of the reflective cup. When only one blue and one green LED (24, 26) are adopted in the second embodiment, the red-light inducible phosphor layer (30) is formed on the mounting surface (12) of the reflective cup to cover the blue LED (24) and the green LED (26) as shown in FIG. 3. When more one the green and blue LEDs (24, 26) are in a ratio, for instance, between 1:0.5 and 1:2, the green or blue LEDs (24, 26) in excess of a ratio of 1:1 are covered by the red-light inducible phosphor layer (30) to generate red light. FIG. 4 illustrates two blue LEDs (24) and one green LED (26), where one blue LED (24) is covered by the red-light inducible phosphor layer (30). FIG. 5 illustrates one blue LED (24) and two green LEDs (26), where one green LED (26) is covered by the red-light inducible phosphor layer (30).

Since the trichromatic light emitting device of the present invention uses blue and green LEDs (24, 26), color shifting and lifetime problems are solved. Moreover, blue and green LEDs (24, 26) use similar based materials so a driving voltage of the blue and green LEDs (24, 26) is very close and a driving circuit for the trichromatic light emitting device is easy and manufacture costs are reduced.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A trichromatic light emitting device comprising
a substrate having a mounting surface;
multiple LEDs being capable of powered by an external power to emit blue and green light along at least one output pathway and being mounted on the mounting surface of the substrate; and
a red-light inducible phosphor layer being disposed in at least one of the at least one output pathway and absorbing blue or green light to produce red light.

2. The trichromatic light emitting device as claimed in claim 1, wherein
the substrate is a printed circuit board;
the LEDs consists of multiple blue and green LEDs that respectively emit blue and green light and are mounted on the mounting surface of the substrate;
the trichromatic light emitting device further has a functional film being allocated on the at least one output pathway; and
the red-light inducible phosphor layer is deposited on the functional film.

3. The trichromatic light emitting device as claimed in claim 1 wherein the LEDs consist of at least one blue and green LEDs being in a ratio, and the green or blue LEDs in excess of the ratio of 1:1 are covered by the red-light inducible phosphor layer.

4. The trichromatic light emitting device as claimed in claim 3, wherein
the substrate is a reflective cup;
two blue LEDs are mounted on the mounting surface of the substrate:
one green LED is mounted on the mounting surface of the substrate; and
the red-light inducible phosphor layer is deposited on one output pathway of one of the blue LEDs.

5. The trichromatic light emitting device as claimed in claim 3, wherein
the substrate is a reflective cup;
one blue LED is mounted on the mounting surface of the substrate;
two green LEDs are mounted on the mounting surface of the substrate; and
the red-light inducible phosphor layer is deposited on one output pathway of one of the green LEDs.

6. The trichromatic light emitting device as claimed in claim 2, wherein the functional film is a polarizer film.

7. The trichromatic light emitting device as claimed in claim 2, wherein the functional film is a Fresnel Lens film.

8. The trichromatic light emitting device as claimed in claim 2, wherein the functional film is a transparent film.

9. The trichromatic light emitting device as claimed in claim 2, wherein the functional film is a color filter film.

10. The trichromatic light emitting device as claimed in claim 2, wherein materials of the red-light inducible phosphor layer is selected from a group consists of SrS:Eu²⁺, (Ba₁₋ₓSrₓ)₂SiO₄:Eu²⁺ and (Ca,Sr,Ba)ₓSi_{y}N_{z}:Eu.

11. The trichromatic light emitting device as claimed in claim 3, wherein materials of the red-light inducible phosphor layer is selected from a group consists of SrS:Eu²⁺, (Ba₁₋ₓSrₓ)₂SiO₄:Eu²⁺ and (Ca,Sr,Ba)ₓSi_{y}N_{z}:Eu.

12. The trichromatic light emitting device as claimed in claim 4, wherein materials of the red-light inducible phosphor layer is selected from a group consists of SrS:Eu²⁺, (Ba₁₋ₓSrₓ)₂SiO₄:Eu²⁺ and (Ca,Sr,Ba)ₓSi_{y}N_{z}:Eu.

13. The trichromatic light emitting device as claimed in claim 5, wherein materials of the red-light inducible phosphor layer is selected from a group consists of SrS:Eu²⁺, (Ba₁₋ₓSrₓ)₂SiO₄:Eu²⁺ and (Ca,Sr,Ba)ₓSi_{y}N_{z}:Eu.
